(19) United States
(12) Patent Application Publication
(10) Pub. No.: US 2015/0120432 A1
(43) Pub. Date: Apr. 30, 2015

(54) GRAPH-BASED RANKING OF ITEMS

(71) Applicant: Microsoft Corporation, Redmond, WA (US)

(72) Inventors: Taifeng Wang, Beijing (CN); Tie-Yan Liu, Beijing (CN); Jiang Bian, Beijing (CN)

(73) Assignee: Microsoft Corporation, Redmond, WA (US)

(21) Appl. No.: 14/066,491

(22) Filed: Oct. 29, 2013

(51) Int. Cl. G06Q 30/02

(52) U.S. Cl. CPC G06Q 30/0242
USPC 705/14.41

(57) ABSTRACT

Graph based evaluation by a computing device or system is described. In some example techniques, one or more subgraph nodes of a relationship subgraph may be generated based at least in part on a presenting of one or more items associated with the one or more associated subgraph nodes to a client. A click indication may be received that indicates the client has selected one of the presented items associated with the nodes. One or more edges of the relationship subgraph may be generated that begin at one or more respective unselected subgraph nodes associated with items presented concurrently with the selected item and end at a subgraph node associated with the selected item.

### BACKGROUND

The continued proliferation of computing and networking in general has led to an increased interest in presenting items of interest to users. For example, when users input queries into search engines, some search engines present sponsored items to users which, if chosen, may generate income for the search engine operator. As such, there is an interest in presenting the items which are likely to be chosen by users to increase the income generated for the search engine operator.

### SUMMARY

Graph based evaluation by a computing device or system is described. In some example techniques, one or more subgraph nodes of a relationship subgraph may be generated based at least in part on a presenting of one or more items associated with the one or more associated subgraph nodes to a client. A click indication may be received that indicates the client has selected one of the presented items associated with the nodes. One or more edges of the relationship subgraph may be generated that begin at one or more respective unselected subgraph nodes associated with items presented concurrently with the selected item and end at a subgraph node associated with the selected item.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The Detailed Description is described with reference to the accompanying figures. The use of the same reference numbers in different figures indicates similar or identical items.

FIG. 1 is a schematic diagram of an illustrative computing architecture.

FIG. 2 is a block diagram of one or more example server in the computing architecture of FIG. 1.

FIG. 3 is a block diagram of an example user interface for receiving search queries and presenting users with advertisements and search results based on the search queries.

FIG. 4 illustrates an example process flow according to some implementations by which, for example, the servers of FIG. 1 may generate a relationship graph that may be utilized to evaluate items presented to users.

FIGS. 5-7 illustrate example relationship subgraphs and/or graphs according to some implementations.

FIGS. 8-13 illustrate example additional relationship subgraphs and/or graphs according to some implementations for evaluating clickability of advertisements.

FIG. 14 illustrates an example process flow according to some implementations by which, for example, the servers of FIG. 1 may generate a relationship subgraph and integrate the relationship subgraph into a relationship graph that may be utilized to evaluate items presented to users.

FIG. 15 illustrates an example hierarchy features that may be utilized to evaluate advertisements presented to users in some implementations.

FIG. 16 illustrates an example neural network that may be utilized to evaluate items based on a plurality of features.

### DETAIL DESCRIPTION

### Overview

This disclosure includes techniques and arrangements for evaluating or rating items using relationship graphs. In some implementations, the techniques and arrangements provide functionality to generate a subgraph based on items presented to a user. Upon receipt of an indication of a user selection of an item presented, the techniques and arrangements provide functionality to generate directed edges indicated of the user's selection. Additionally, the techniques and arrangements may provide for the integration of the subgraph into a subgraph for multiple reason stations of items to users. Moreover, the techniques and arrangements may also provide the functionality to utilize the relationship subgraph to determine the rating of the items represented by nodes of the relationship graph.

Although the discussion herein may describe some implementations in which a user device or user is presented with search results based on a query, other implementations are not so limited, and the techniques and methods discussed herein may be performed by other computing devices such as client devices, network devices, etc.

The relationship graph based evaluation system and techniques described herein may be implemented at various levels in the software and hardware of computing systems. Such levels include the Operating System (OS) level, such as in the OS with or without application support, the application level, either separate from the OS (i.e., stand-alone) or as a plug-in to the OS or a plug-in to another application and so forth. It should also be noted that, for readability, interactions between modules may be described herein as signals or commands, but such interactions may be implemented in various ways, such as by function calls between various program modules.

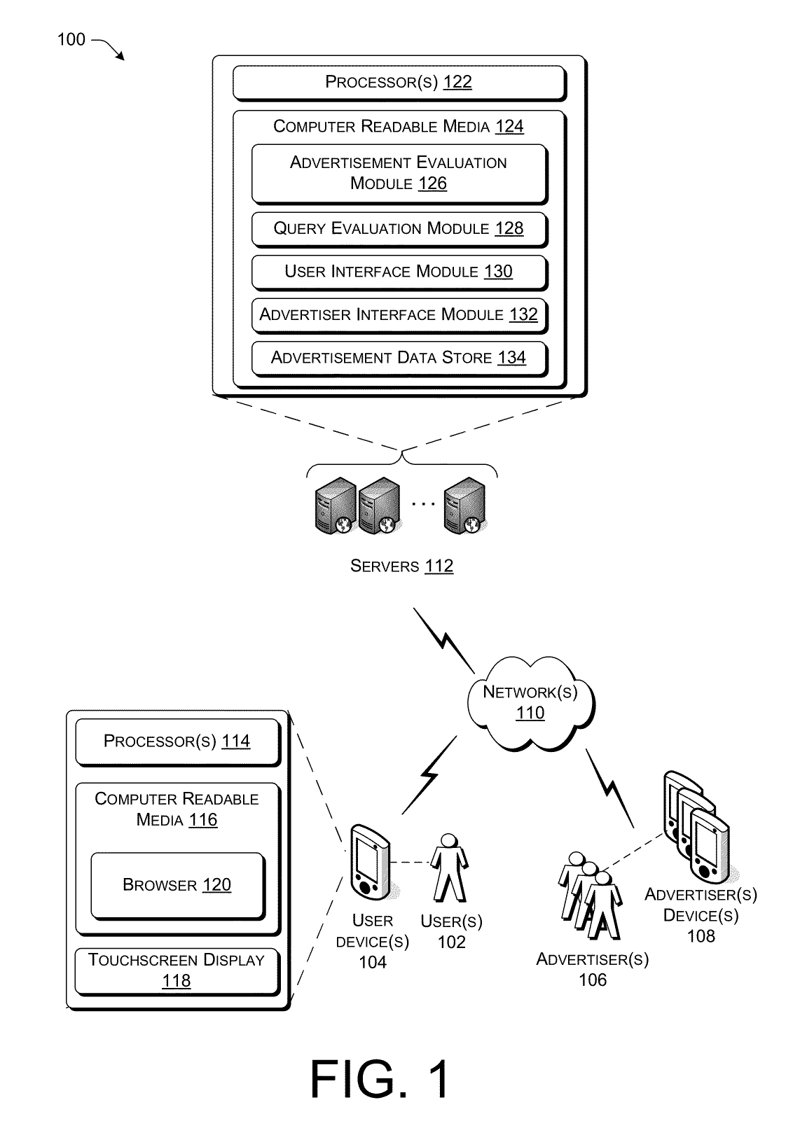

FIG. 1 illustrates an example system 100 for evaluating the desirability of items presented to clients. As illustrated in FIG. 1, in some implementations, the items being evaluated may be advertisements presented to users in a web browser. For example, the desirability may be a measure of the “clickability” of the advertisements when presented to the users in a web browser in response to search queries. More particularly, in some implementations, the system 100 may provide for the evaluation of the clickability of advertisements based at least in part on the queries submitted by the user and click relationships between the advertisements. As shown in FIG. 1, the system 100 may include one or more user(s) 102, one or more user device(s) 104 associated with the user(s) 102, one or more advertiser(s) 106, one or more advertiser device(s) 108 associated with the advertiser(s) 106, one or more network(s) 110 and one or more server(s) 112.

In various implementations, the users 102 may operate the user devices 104, which may include one or more processor(s) 114, computer-readable media 116 and a touchscreen display 118. The computer readable media 116 may include a web browser 120.

The servers 112 may also include one or more processor(s) 122 and computer-readable media 124, which may include an advertisement evaluation module 126, a query evaluation module 128, a user interface module 130, an advertiser interface module 132, and an advertisement data store 134. In some implementations, the server(s) 112 may be part of a larger service such as a search engine service. The server(s) 112 may include one or more machines (e.g., one or more server computer systems, routers, gateways, etc.) that have processing and storage capabilities to provide the functionality of a search engine and/or advertisement service in general in addition to the functionality discussed below (e.g., distributed computing over a network and running an application on many connected computers at the same time to provide a search engine service that includes the presentation of advertisements). Of course, implementations are not so limited and the techniques and arrangements in accordance with this disclosure may be utilized in conjunction with any type of network architecture.

In some implementations, the user 102 may operate the user device 104 to perform various functions associated with the user device 104, which may include the one or more processor(s) 114, the computer-readable media 116 and the touchscreen display 118. The processor(s) 114 of the user device 104 may execute one or more modules and/or processes to cause the user device 104 to perform a variety of functions, as set forth above and explained in further detail in the following disclosure. In some implementations, the processor(s) 114 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc.

Additionally, each of the processor(s) 114 may possess its own local memory, which also may store program modules, program data, and/or one or more operating systems. The advertiser device(s) 108 may comprise component similar to those of the user device(s) 104.

Viewing the operation of the system 100 at this depth, advertiser(s) 106 may utilize the advertiser(s) device(s) 108 to submit advertisements (or other items) that are to be presented to users of a search engine service of the servers 112. More particularly, in some implementations, the advertiser(s) may submit the advertisements to the search engine service of the servers 112 across the network(s) 110 under an agreement that provides compensation to the operator(s) of the search engine service based on a number of clicks or selections by users that choose advertisements of the respective advertiser(s). For example, an advertiser may agree to compensate the operator of the search engine service a set value for each click by each distinct user within a certain timeframe. Of course, this just an example and the implementations of the techniques and systems disclosed herein are not so limited.

The advertiser interface module 132 may receive the advertisements submitted by the advertiser(s) 106 and conduct any interactions with the advertiser(s) 106 regarding presentation, compensation and similar details for the submitted advertisements. The advertiser interface module 132 may then store the advertisement(s) and associated information in the advertisement data store 134.

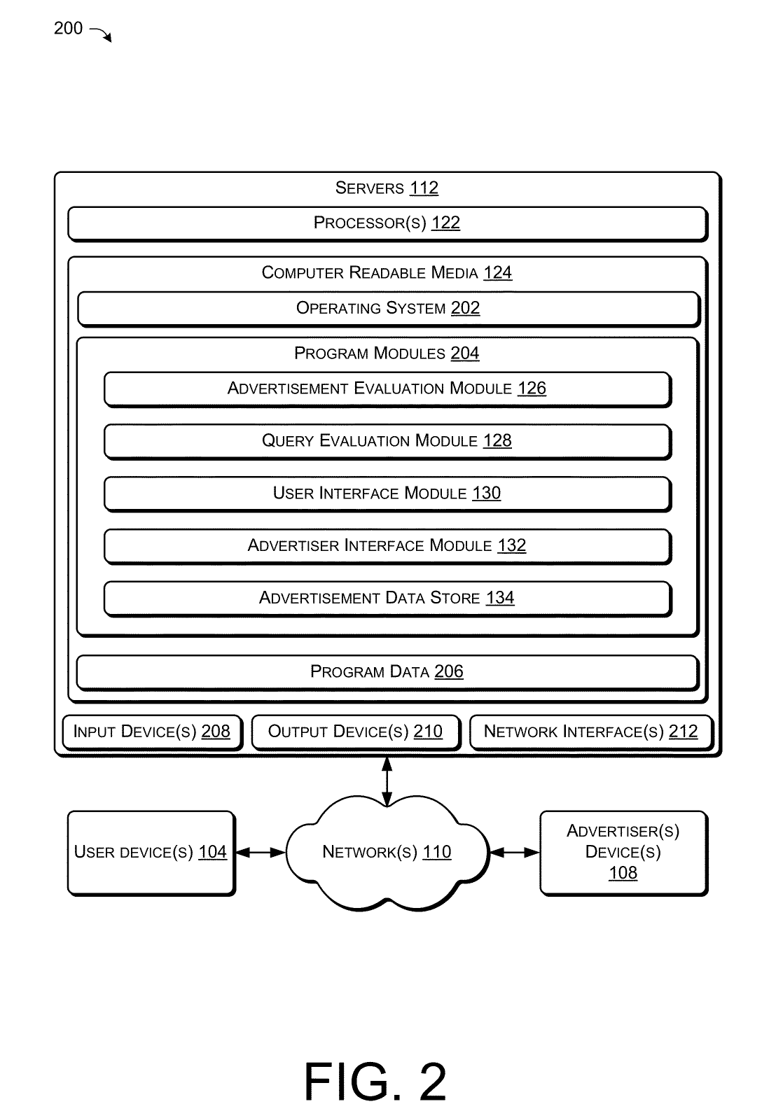

The advertisement data store 134 may also store clickability rating information relating to the advertisements. The determination and generation of the clickability rating information is discussed below with regard to FIGS. 2-16.

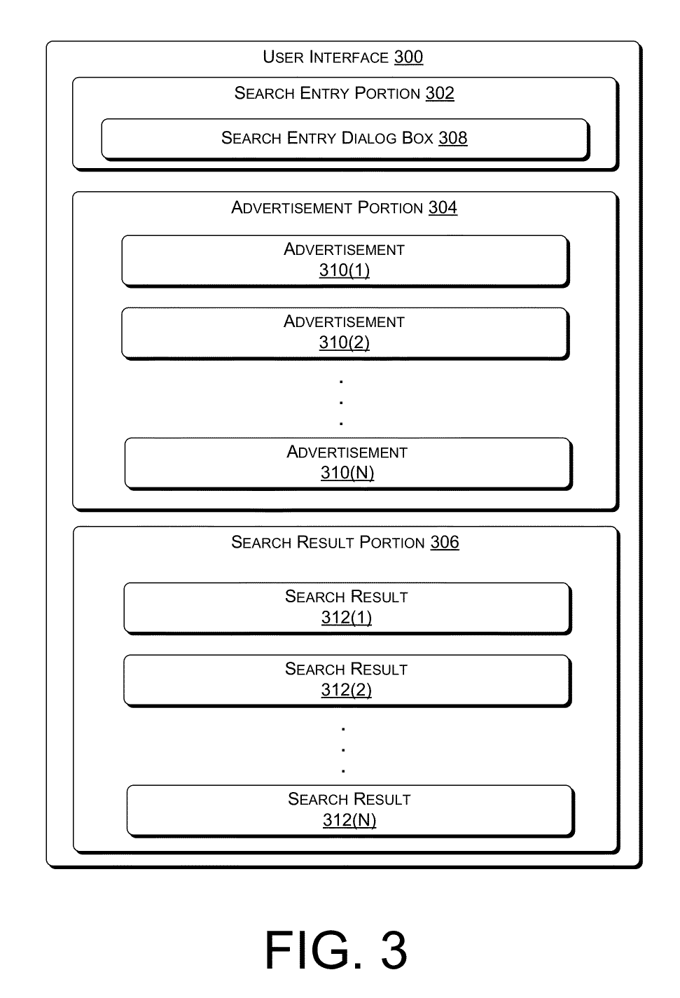

Subsequently, a user 102 may utilize the browser program 120 operating on a user device 104 of the user 102 to submit a search query to the servers 112. The user interface module 130 of the servers 112 may receive the search query. The user interface module 130 may then interact with the query evaluation module 128 to determine search results to be presented to the user 102 in response to the search query. Further, the query evaluation module 128 may search the advertisements stored in the advertisement data store 134 based on various information such as the clickability rating information, the search query, keyword information, advertisement parameters and/or features, and the like to determine one or more advertisements to be presented in conjunction with the results of the search query. An example user interface by which the user may enter a search query and be presented search results in conjunction with one or more advertisements is shown in FIG. 3 and is described below.

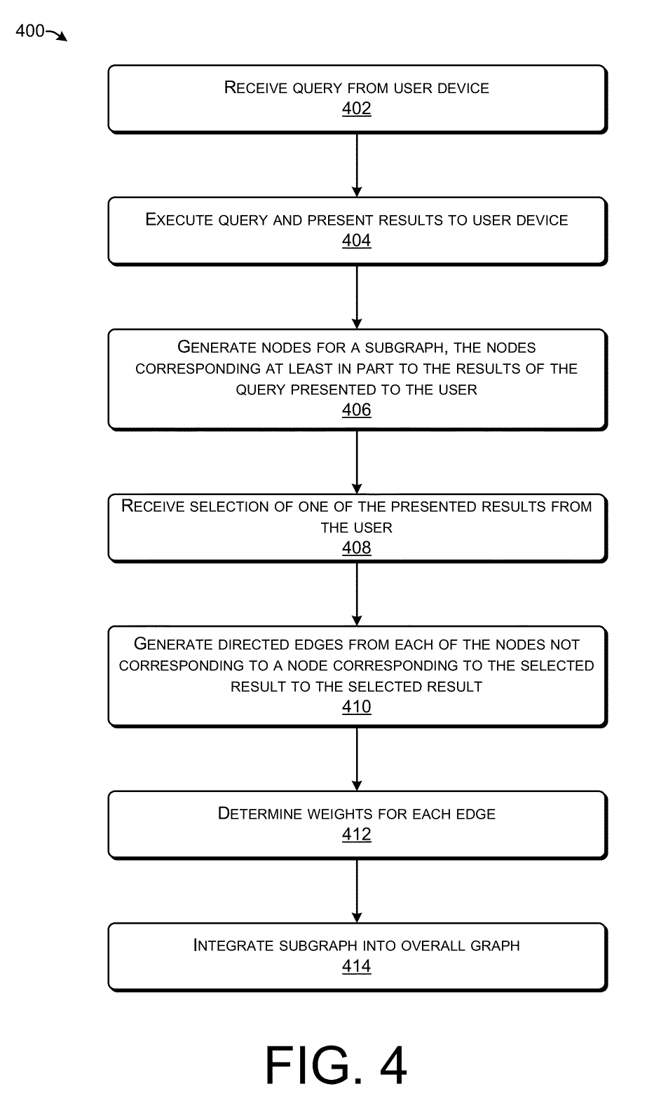

Subsequent to returning the search results and advertisements to the user device 104 for presentation to the user 102 in the browser 120, the servers 112 may receive click information that may indicate that the user has clicked or selected one or more of the search results and/or advertisements. Based at least in part on the click information, the advertisement evaluation module 126 may operate to determine clickability rankings for the advertisements stored in the advertisement data store 134. Example techniques and systems for determining clickability rankings are set forth below with regard to FIGS. 4-16.

The system 100 is but one example system in which the techniques and arrangements may operate and is provided to allow for an example context for the explanation to follow. The techniques and arrangements are not limited to this example environment. For example, the system set forth above is discussed as determining clickability rankings on an ad hoc basis (i.e., as click information is received). In other examples, the system 100 may operate as a “batch” type system in which the advertisement evaluation module 126 may operate to determine clickability rankings periodically or upon collection of a predetermined amount of click information).

Additionally, though the advertisers devices 108 are illustrated in the diagram of FIG. 1 as separate from the servers 112, implementations are not so limited and may include implementations in which the advertisers devices 108 and the servers 112 are implemented as one system, either in a distributed or non-distributed fashion.

The above discussion provides details and examples related to FIG. 1 and the disclosed systems and techniques in general. However, the above discussion is not limiting and many variations are possible and will be appreciated in view of this disclosure. For example, while the servers 112 are illustrated in FIG. 1 as implementing an advertisement evaluation module 126 that performs clickability evaluations of advertisements, implementations of the disclosed systems and techniques are not so limited. For example, in some implementations, the servers 112 may also or instead include a module that performs similar clickability evaluations of search results (e.g., the search evaluation module). Further, implementations may also be directed to evaluations of items outside of the context of web browsers and search engines.

For example, the relationship graph-based evaluation techniques disclosed herein may be applied to user interface systems and techniques that evaluate the intended user input. For example, the techniques described herein may be utilized with regard to determining suggestions provided by input method editors (IMEs). More particularly, some input method editors utilize a current state of user input to present optional completion suggestion for a user to select. The relationship graph-based evaluation techniques disclosed herein may be utilized to evaluate and/or rate the completion suggestion to present to the user. In a more particular example, a IME may utilize the techniques disclosed herein to determine words to suggest as completions for a partially input word. The techniques disclosed herein may similarly be applied to handwriting recognition, speech recognition systems, gesture recognition systems and/or other user interface systems, as well as systems outside of user interfaces systems as would be understood by one or ordinary skill in the art in view of this disclosure. As mentioned above, additional details of the advertisement evaluation module 126 (or similar evaluation modules) are provided with respect to FIGS. 4-16.

FIG. 2 is a block diagram 200 illustrating an example configuration of the servers 112 of FIG. 1. As discussed above regarding FIG. 1, the servers 112 may include one or more processor(s) 122. The processor(s) 122 may be implemented as one or more a central processing unit (CPU), a graphics processing unit (GPU), microprocessors, microcomputers, microcontrollers, digital signal processors, central processing units, state machines, logic circuitries, and/or any devices that manipulate signals based on operational instructions. As one example, the processor(s) 122 may be one or more hardware processors and/or logic circuits of any suitable type specifically programmed or configured to execute the algorithms and processes described herein. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Among other capabilities, the processor(s) 122 can be configured to fetch and execute computer-readable instructions stored in the computer-readable media 124.

The servers 112 may also include one or more computer-readable media 124. The computer-readable media 124 may store information which provides an operating system component 202, various program modules 204 such as the above described advertisement evaluation module 126, the query evaluation module 128, the user interface module 130, the advertiser interface module 132 and the advertisement data store 134, program data 206, and/or other components. In one example, the servers 112 perform functions by using the processor(s) 122 to execute instructions provided by the computer-readable media 124.

As used herein, “computer-readable media” includes, at least, two types of computer-readable media, namely computer storage media and communications media.

As used herein, computer storage media or computer-readable storage media may correspond to any combination of volatile and/or non-volatile storage mechanisms. Depending on the configuration of the servers 112, the computer-readable media 124 may be an example of a computer storage media for storing instructions which are executed by the processor 122 to perform the various functions described herein. For example, the computer-readable media 124 may generally include both volatile memory and non-volatile memory (e.g., RAM, ROM, or the like). Further, the computer-readable media 124 may generally include hard disk drives, solid-state drives, removable media, including external and removable drives, memory cards, flash memory, floppy disks, optical disks (e.g., CD, DVD and/or high-density optical disks), a storage array, a network attached storage, a storage area network, or the like. The computer-readable media 124 may be referred to as memory or computer storage media herein, and may be a media capable of storing computer-readable, processor-executable program instructions as computer program code that can be executed by the processor 122 as a particular machine configured for carrying out the operations and functions described in the implementations herein.

In contrast, communication media embody computer readable instructions, data structures, program modules, or other data in a modulated data signal, such as a carrier wave, or other transmission mechanism. As defined herein, computer storage media does not include communication media or signals per se.

The servers 112 may also include one or more input devices 208 (keyboard, mouse device, specialized selection keys, a touchscreen display which may operate in response to touches, gestures, etc.) and one or more output devices 210 (a display (touchscreen or otherwise), printers, audio output mechanisms, etc.).

The servers 112 further include one or more network interface(s) 212 to allow the servers 112 to communicate via a network (e.g., such as the network(s) 110) with other computing devices, such as remote computers, the user devices 104, the advertisers devices 108 and so forth.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., processors 114 or 122). The program code can be stored in one or more computer-readable memory devices or other computer storage devices (e.g., computer-readable media 116 or 124). Thus, the processes, components and modules described herein may be implemented by a computer program product.

FIG. 3 illustrates an example user interface 300 that may be presented to a user 102 in the web browser 120 of a user device 104. As shown in FIG. 3, the user interface 300 may include a search entry portion 302, an advertisement portion 304 and a search result portion 306.

In operation, the user may enter a search query into a search entry dialog box 308 of the search entry portion 302 of the user interface 300 to submit the search query to the servers 112. The servers 112 may process the search query in the manner discussed above with regard to FIG. 1 and return advertisements 310(1)-310(N) along with search results 312(1)-312(N) to the user device 104 for presentation to the user. Upon receiving the advertisements 310(1)-310(N) and search results 312(1)-312(N), the web browser 120 of the user device 104 may present the advertisements 310(1)-310(N) in the advertisement portion 304 of the user interface 300 and present the search results 312(1)-312(N) in the search result portion 306 of the user interface 300. Subsequent to the presentation of the search results and advertisements to the user, the user 102 may click one or more of the advertisements or search results to go to a webpage linked by the clicked item. Upon receiving the click, the user interface 300 may cause the user device 104 to provide click information to the servers 112 for use in clickability ranking determinations or similar evaluations as described below.

As mentioned above, some implementations of the techniques and systems described herein utilize relationship graphs in determining ratings, such as the aforementioned advertisement clickability ratings. Implementations utilizing such relationship graphs are described below with regard to FIGS. 4-16 in the context of items presented to users in the interface 300.

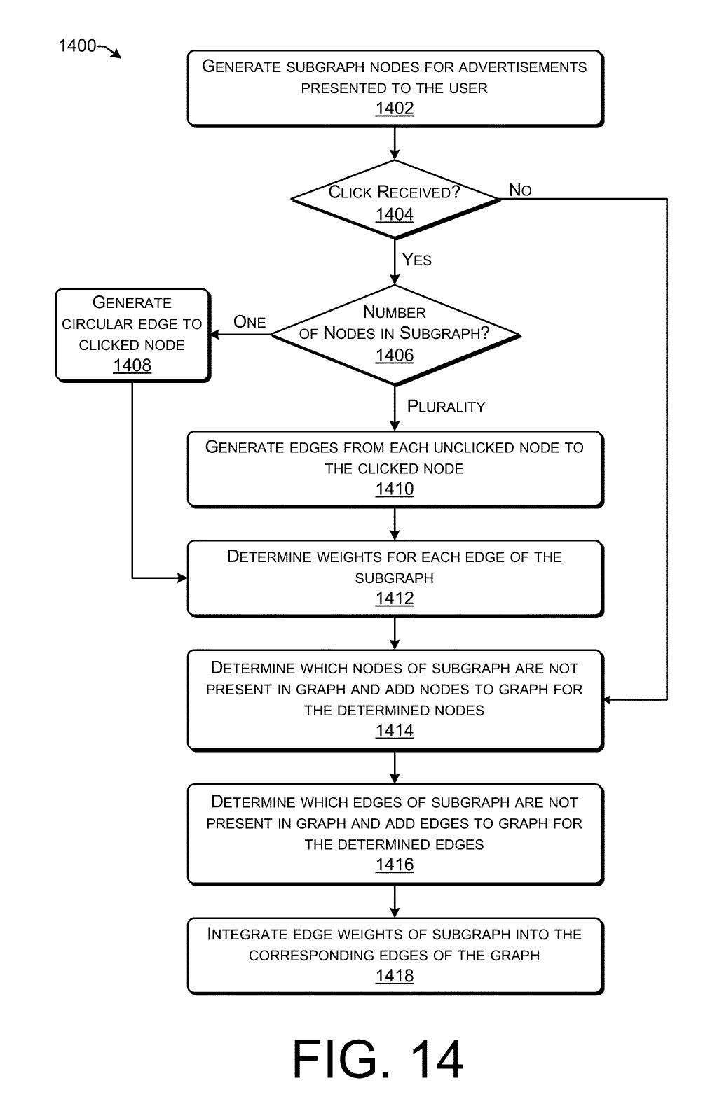

FIG. 4 illustrates an example process flow 400 according to some implementations. In particular, the process flow 400 illustrates an example process by which relationship graphs may be generated based on information derived from user selections of items presented in the interface 300 shown in FIG. 3. In some implementations, an edge directed from a first node to a second node in a relationship graph may be said to indicate that the first node “recommends” the second node. Stated another way, the edge may indicate that the user(s) whose selection is represented by the edge preferred the second node over the first node. As such, this information may be used to determine clickability ratings for the items represented by the nodes based on the relationship between the nodes. Of course, while user interface 300 is used as an example for the presentation of items to the user in the discussion below, this is merely an example and various other means of presentation of items to users for selection may be utilized in some implementations. In the flow diagram of FIG. 4, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the process flow 400 is described with reference to the system 100, described above, although other models, frameworks, systems and environments may implement the illustrated process. Other processes described throughout this disclosure (e.g., those shown in FIG. 14), in addition to process 400, shall also be interpreted accordingly.

At 402, for example, when a user 102 enters a query into the search entry dialog box 308 of the user interface 300. The user interface 300 causes the user device 104 to send the query to the servers 112 via the user interface module 130 for processing. At 404, the query evaluation module 128 of the servers 112 may operate to execute the query to determine query search results and/or one or more advertisements to be presented to the user 102 via the user interface 300. The user interface module 130 causes the servers 112 to sends the results to the user device 104 for presentation to the user 102.

At 406, the system 112 may operate to generate the nodes of a subgraph where the nodes correspond at least in part to the results of the query being presented to the user. For example, in an implementation in which the advertisements 310(1)-310(N) are presented to the user in the advertisement portion 304 and relationship graph based ratings are to be generated for advertisements, the advertisement evaluation module 126 may generate nodes that correspond at least in part to the advertisements 310(1)-310(N). In another example implementation in which the search results being presented to the user in the search result portion 306 are to be rated using relationship graph based ratings, the query evaluation module 128 may generate nodes that correspond to the search results 312(1)-3102(N).

At 408, the user interface 300 may receive selection of one of the presented results from the user 102. The user interface 300 may then cause the user device 104 to submit click information data to the user interface module 130 of the servers 112 for use in generating the relationship graph.

At 410, the system 112 may operate to generate directed edges for a relationship subgraph. More particularly, the system 112 may generate directed edges from each of the nodes generated at 406 which do not correspond to the selected item to the node corresponding to the selected item. At 412, the system 112 may operate to determine weights for the directed edges of the relationship subgraph. As with 406, depending on the implementation and the items to be evaluated, the generation of the directed edges and the assignment of weights to the directed edges may be performed by, for example, the advertisement evaluation module 126 or the query evaluation module 128.

At 414, the advertisement evaluation module 126 may integrate the subgraph for the particular query into a relationship graph that includes nodes and edges corresponding to other queries and clicks.

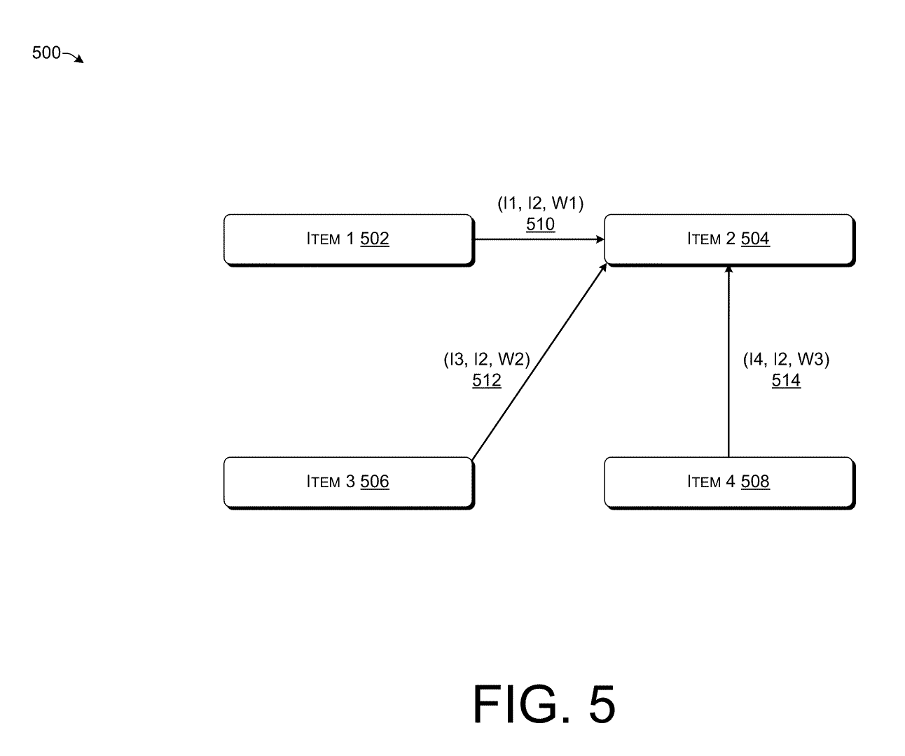

More details regarding the generation of nodes, the determination of weights for directed edges, and the integration of relationship subgraphs into an overall relationship graph from multiple queries is provided below with regard to FIGS. 5-14. For readability and to avoid prolix description, discussion of functionality below which may be performed by the advertisement evaluation module 126, the query evaluation module 128 or other evaluation modules will be discussed as being performed by the advertisement evaluation module 126. Of course, this is by no means intended as a limitation.

FIG. 5 illustrates a relationship subgraph 500 that represents click or selection information between the four items presented to a user according to some implementations. The relationship subgraph 500 may be generated according to the process described above and in more detail below.

As previously discussed, when four items are presented to a user, a relationship subgraph including four nodes associated with the four items may be generated (i.e. nodes labeled item 1 502, item 2 504, item 3 506 and item 4 508). Click information may then be received that indicates the user clicked item 2. Based on the click information, directed edges may be generated from the nodes representing items that were not clicked to the node representing the item that was clicked. As such, in response to the user clicking item 2, edges (I1, I2, W1) 510, (I3, I2, W2) 512, and (I4, I2, W3) 514 may be generated. The advertisement evaluation module 126 may determine weights for the edges of the relationship subgraph 500. The labeling of edges given herein has the following form: (start node, end node, edge weight). As such, the label of edge 510 could be written as (item 1, item 2, weight 1).

The manner of determining the weights may vary from implementation to implementation. For example, in some implementations, the weights may be determined based on information that indicative of an aspect of the presentation of the items corresponding to the nodes. More particularly, in some implementations, the weights may be based on information indicative of position, order of presentation, size of the presented items, relevance of the items to the query, and/or other features. For example, if the items represented by nodes 502-508 are presented in numeric order on a webpage (i.e. from top to bottom in the user interface 300), the edge weighting may account for position bias. Position bias refers to the assumption that users review results presented on webpages in order and, as such, the user has a higher likelihood of clicking a result positioned such that the user reviews the item before a subsequently positioned item. As such, a “recommendation” from a lower positioned item to a higher positioned item has a lower value than a recommendation from a higher positioned item to a lower positioned item. An example rationale for accounting for position bias is that a user may simply have not reviewed the lower positioned item before selecting the higher positioned item. As such, there may be less confidence that the user actually preferred the higher positioned item over the lower position item.

For example, in some implementations, a position curve indicating the position bias may be utilized (e.g., [p1, p2, p3, p4]=[1, 0.6, 0.4, 0.25] for the top 4 position a result list). As such, if the original edge weights are {w_{—}1, w_{—}2 and w_{—}3}=[1,1,1], the adjusted edge weight may be determined as w_{i,j}=pi/pj*1. Therefore, if a higher position item recommends a lower positioned item, the edge weight will be greater than one. Otherwise, the edge will be smaller than one. In this way, position bias may be addressed.

In addition, other features, such as semantic features, may be utilized in determining edge weight. For example, the edge weight can be further adjusted based on the semantic features using the following formula:

$${w}_{i , j} = \frac{{p}_{i}}{{p}_{j}} * f ( {r}_{i} , {r}_{j} , {a}_{i} , {a}_{j} , … )$$

In the above formula, rᵢ is a relevance score of item-i, and aᵢ is the attractiveness score of item-i. Thus, using the above formula, the weighting of edges may take into account at least the position bias, relevance score and attractiveness score of items presented to users.

Following the generation of the subgraph 500, subgraph 500 may be integrated with an overall relationship graph representing the clickability of items being presented to users. For the purposes of the discussion of FIGS. 5-7, it is assumed herein that the subgraph 500 is the first subgraph generated by the system and thus becomes the overall relational graph representing the clickability of the items presented to users by the corresponding system.

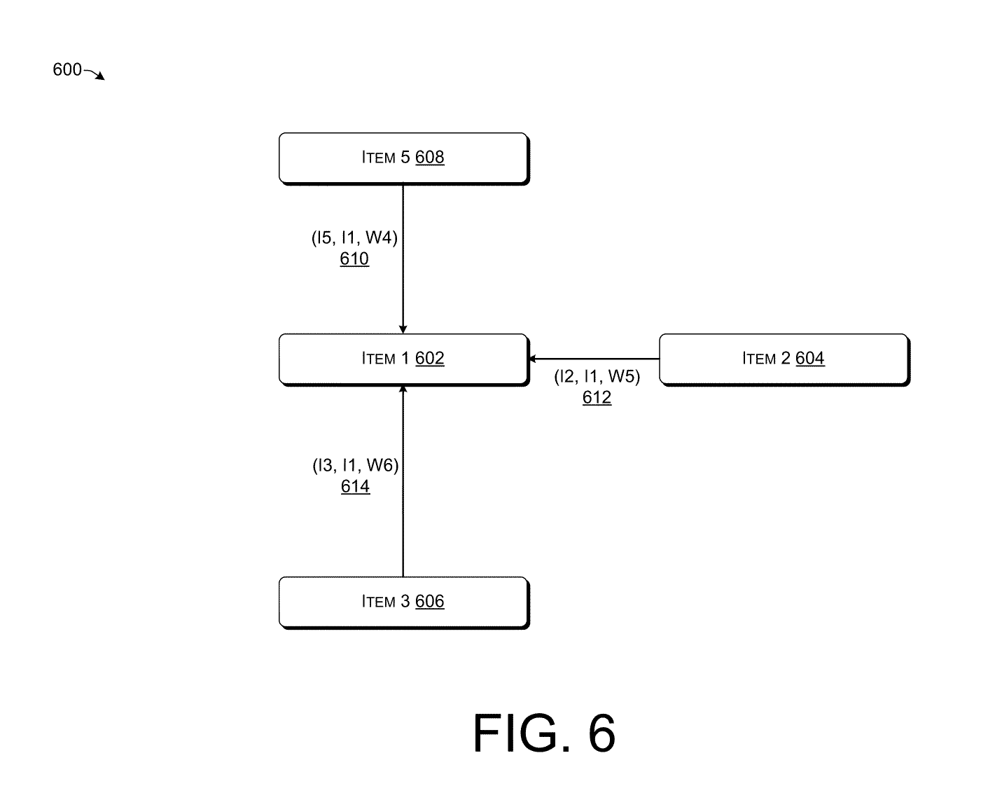

FIG. 6 illustrates another relationship subgraph 600 that represents click or selection information for a different set of four items presented to a user according to some implementations. For the purposes of discussion and explanation, it is assumed that the presentation of the items represented in FIG. 6 is in response to a similar query and occurs following the presentation of the items represented in FIG. 5.

In particular, three items from FIG. 5, item 1, item 2 and item 3, are again presented to the user along with a new item, item 5. As such, four nodes are generated for the relationship subgraphs 600 (i.e., nodes labeled item 1 602, item 2 604, item 3 606 and item 5 608). Click information may then be received indicating that the user chose item 1. As such, the advertisement evaluation module 126 may generate directed edges from the nodes representing items that were not clicked to the node representing the clicked item (i.e. an edge from each of the nodes representing item 2 604, item 3 606 and item 5 608 to the node representing item 1 602). Once edges have been added to the subgraph 600, the advertisement evaluation module 126 may determine edge weights. These weighted edges are shown in FIG. 6 as edges (I5, I1, W4) 610, (I2, I1, W5) 612, and (I3, I1, W6) 614.

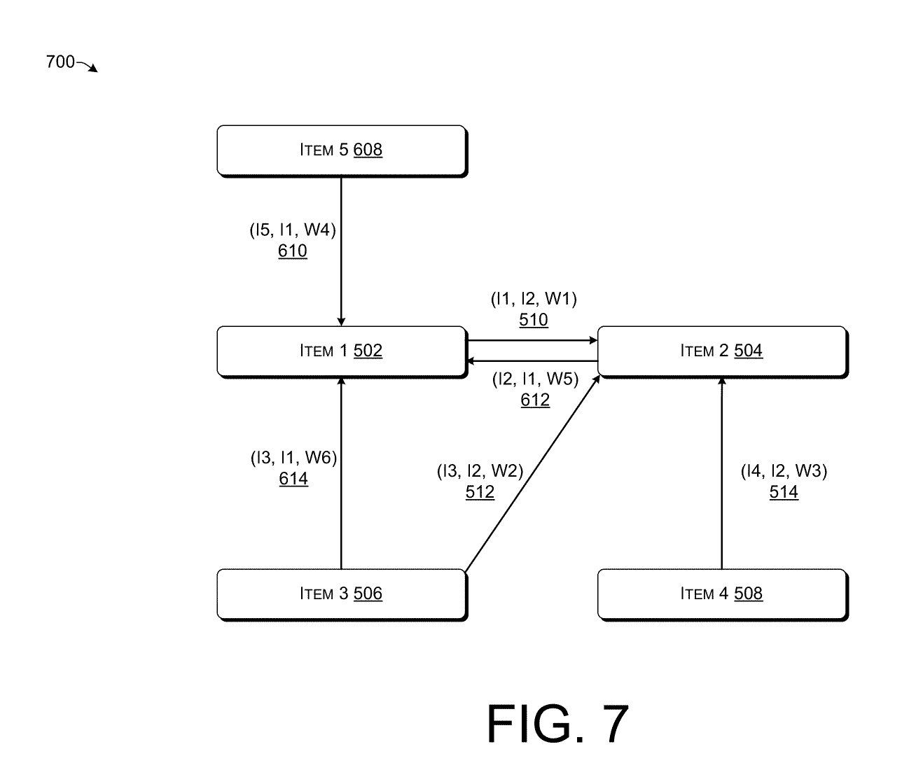

Following the generation of subgraph 600, subgraph 600 may be integrated into the overall relational graph representing the clickability of the items presented to users by the corresponding system (i.e. now referred to for convenience as relationship graph 500). The result of integrating the relationship graph 500 with the relationship subgraph 600 is shown and described with regard to FIG. 7 below.

FIG. 7 illustrates an example relationship graph 700 that represents an integration of the relationship graph 500 with the relationship subgraph 600. The integration may be performed as follows.

The advertisement evaluation module 126 may determine which, if any, of the nodes in the relationship subgraph 600 to be integrated into the relationship graph 500 do not have corresponding nodes present in the relationship graph 500. In the scenario being discussed, nodes 602-606 correspond to nodes 502-506. On the other hand, the node representing item 5 608 does not have a corresponding node in the relationship graph 500. The advertisement evaluation module 126 may then add the nodes without correspondence to the overall relationship graph. This is illustrated in FIG. 7 by adding the node corresponding to item 5 608 to the relationship graph 700.

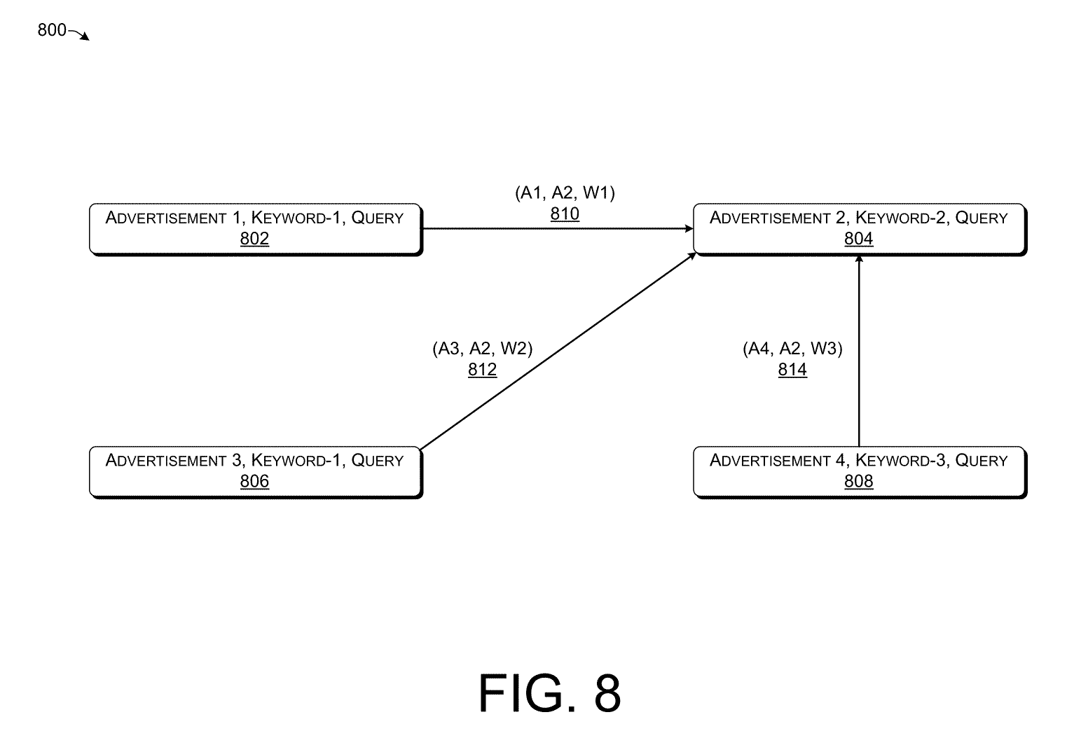

Next, the advertisement evaluation module 126 may add edges present in the relationship subgraph 600 without a corresponding edge in the relationship graph 500 to the relationship graph 700. In the illustrated scenario, the edges 610-614 have no corresponding edges in the relationship graph 500. As such, the edges 610-614 are added to the relationship graph 700. For edges of the subgraph 600 having correspondence to edges of the relationship graph 500, the advertising evaluation module 126 may also perform a summation of the weights of the edges of the relationship graph 500 with the weights of the corresponding edges in the relationship subgraph 600. This is not a current scenario illustrated in FIGS. 5-7 and will be discussed in more detail below with regard to the scenario illustrated in FIGS. 8-12.

FIGS. 8-12 illustrate an example implementation for a scenario in which the operator of the servers 112 provides sponsored advertisements to users along with the results of the users' search queries. In particular, the advertisers 106 may provide advertisements to be presented to users via the advertiser interface module 132 of the servers 112. In the illustrated scenario, the advertisers may also bid or purchase keyword associations from the operator of the servers 112. In some implementations, when a user's query includes one or more of the keywords associated with a particular advertisement, that advertisement may, depending on one or other factors, be presented as a sponsored advertisement along with the results of the user's query. For example, the advertisement may be included in the advertisement portion 304 of the user interface 300 when the search results are displayed to the user.

In such a scenario, each nodes of the relationship graph may correspond to a set of multiple features (one feature being the advertisement itself). More particularly, in the scenario illustrated in FIGS. 8-12, the set of multiple features is a triple of the advertisement, a matched keyword and the query. Thus, in some implementations, a relationship graph may include a plurality of nodes for any given advertisement, wherein each of the plurality of nodes for a given advertisement has a different query/keyword pair.

FIG. 8 illustrates another relationship subgraph 800 according to some implementations that represents click or selection information for a set of four items presented to a user in response to a user query. The state shown in FIG. 8 is the state of the relationship subgraph 800 subsequent to the processing of an indication that the user clicked one of the advertisements (i.e. advertisement 2).

As mentioned above, each node corresponds to a triple of an advertisement, a matched keyword and the query submitted by the user. In particular, node 802 represents an advertisement 1, a matched keyword-1 and the search query. Node 804 represents an advertisement 2, a matched keyword-2 and the search query. Node 806 represents an advertisement 3, the matched keyword-1 that also appeared in node 802 and search query. Node 808 represents an advertisement 4, a matched keyword-3 and the search query. As mentioned above, the same keyword appears in nodes 802 and 806 (i.e. keyword-1). In the illustrated scenario, this may indicate that the advertisers corresponding to advertisements 1 and 3 bid or purchased the same keyword from the operator of the servers 112.

In the illustrated scenario of FIG. 8, the user clicked advertisement 2 upon presentation and that click information is provided to the advertisement evaluation module 126. Using the click information, the advertisement evaluation module 126 adds the edges (A1, A2, W1) 810, (A3, A2, W2) 812 and (A4, A2, W3) 814 to the relationship subgraph 800. As discussed above with regard to FIGS. 5-7, each edge 810-814 may have a respective weight based on various factors such as position bias.

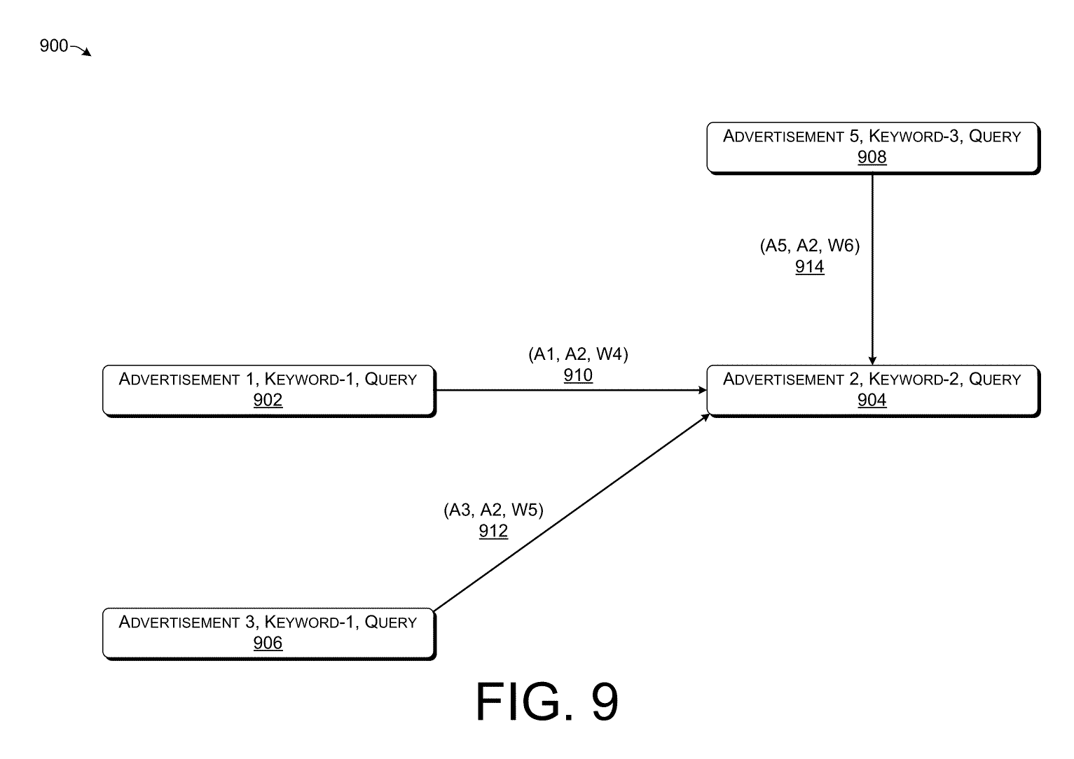

For the discussion of FIGS. 9-12 herein, it is assumed that the relationship subgraph 800 was the initial relationship subgraph created by the servers 112 and thus functions as the initial relationship graph for the processing discussed for FIGS. 9-12.

FIG. 9 illustrates another relationship subgraph 900 according to some implementations that represents click or selection information for a different set of advertisement items presented to a user following the submission of the same query as submitted with respect to FIG. 8. For the purposes of discussion and explanation, it is assumed that the presentation of the items represented in FIG. 9 is in response to a query submitted following the presentation the items represented FIG. 8. It should be noted that the user may be the same or a different user.

Three items from FIG. 8, advertisements 1, advertisements 2 and advertisements 3, are again presented to the user based on the same keyword/query matching information along with a new item, advertisement 5. Advertisement 5 is presented to the user based on a match with keyword-3, the keyword previously matched to advertisement 4 in FIG. 8.

Upon determination of the advertisements to be presented, the advertisement evaluation module 126 may generate the four nodes of the relationship subgraph 900. In particular, nodes 902-906 represent the same triples as nodes 802-806. Node 908 represents an advertisement 5, the keyword-3 and the search query.

The click information may then be received that indicates the user chose advertisement 2 again. As such, the advertisement evaluation module 126 may generate edges from the nodes representing items that were not clicked to the node representing the clicked item (i.e. an edge from each of the nodes 902, 906, and 908 to node 904). Once edges have been added to the subgraph 900, the advertisement evaluation module 126 may determine edge weights. The edges are shown in FIG. 9 as edges (A1, A2, W4) 910, (A3, A2, W5) 912, and (A5, A2, W6) 914.

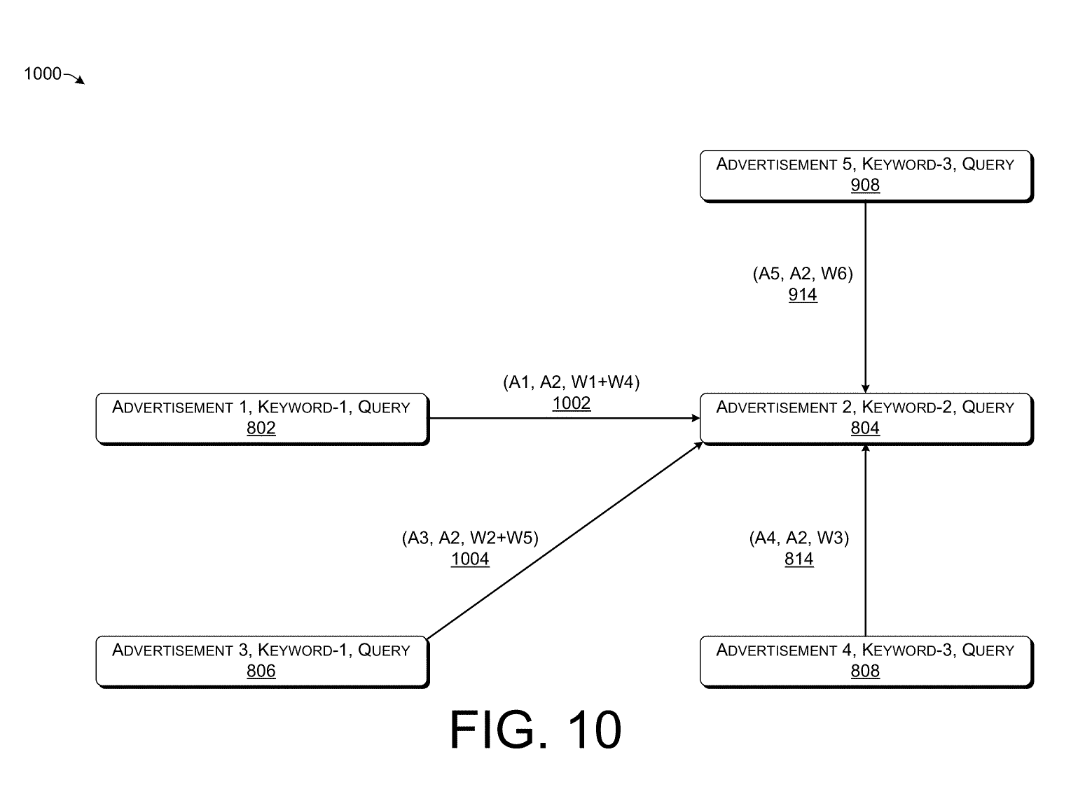

Following the generation of subgraph 900, subgraph 900 may be integrated into the relational graph 800 representing the clickability of the items presented to users by the corresponding system. The result of integrating the relationship graph 800 with the relationship subgraph 900 is shown and described with to regard FIG. 10 below.

FIG. 10 illustrates the relationship graph 1000 that represents an integration of the relationship graph 800 with the relationship subgraph 900. The integration may be performed as follows.

The advertisement evaluation module 126 may determine which, if any, of the nodes in the relationship subgraph 900 to be integrated into the relationship graph 800 do not have corresponding nodes present in the relationship graph 800. In the scenario being discussed, nodes 902-906 correspond to nodes 802-806. On the other hand, the node 908 representing advertisement 5, keyword-3 and the query does not have a corresponding node in the relationship graph 800. The advertisement evaluation module 126 may then add the nodes without correspondence to the overall relationship graph. This is illustrated in FIG. 10 by adding the node 908 to the relationship graph 1000.

Next, the advertisement evaluation module 126 may add edges present in the relationship subgraph 900 without a corresponding edge in the relationship graph 800 to the relationship graph 1000. In the illustrated scenario, the edges 910-914 have corresponding edges in the relationship graph 800. On the other hand, edge 914 does not have a corresponding edge in the relationship graph 800. As such, edge 914 is added to the relationship graph 1000.

The advertising evaluation module 126 may then perform a summation of the weights of edges present in the relationship graph 800 with the weights of corresponding edges in the relationship subgraph 900. As such, edges 810 and 812 become edges 1002 and 1004. Edges 1002 and 1004 have the same start and end nodes as edges 810 and 812, respectively. However, the weights of edges 1002 and 1004 are the summations of the weights of edges 810 and 812 with edges 910 and 912, respectively.

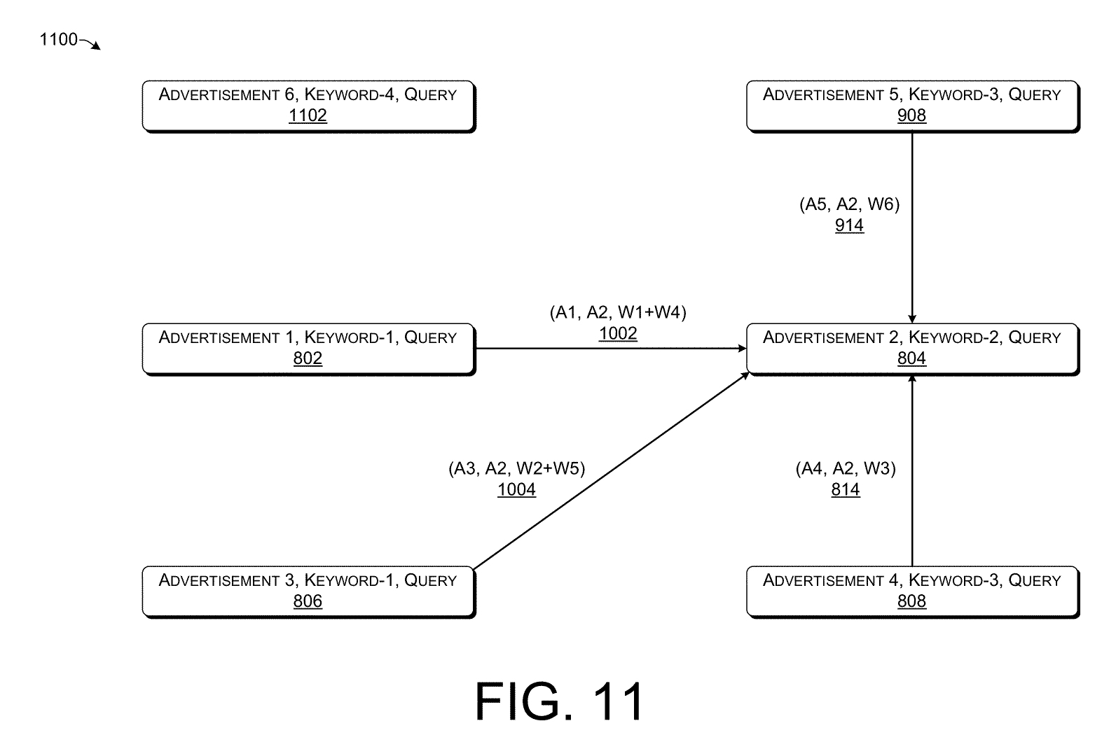

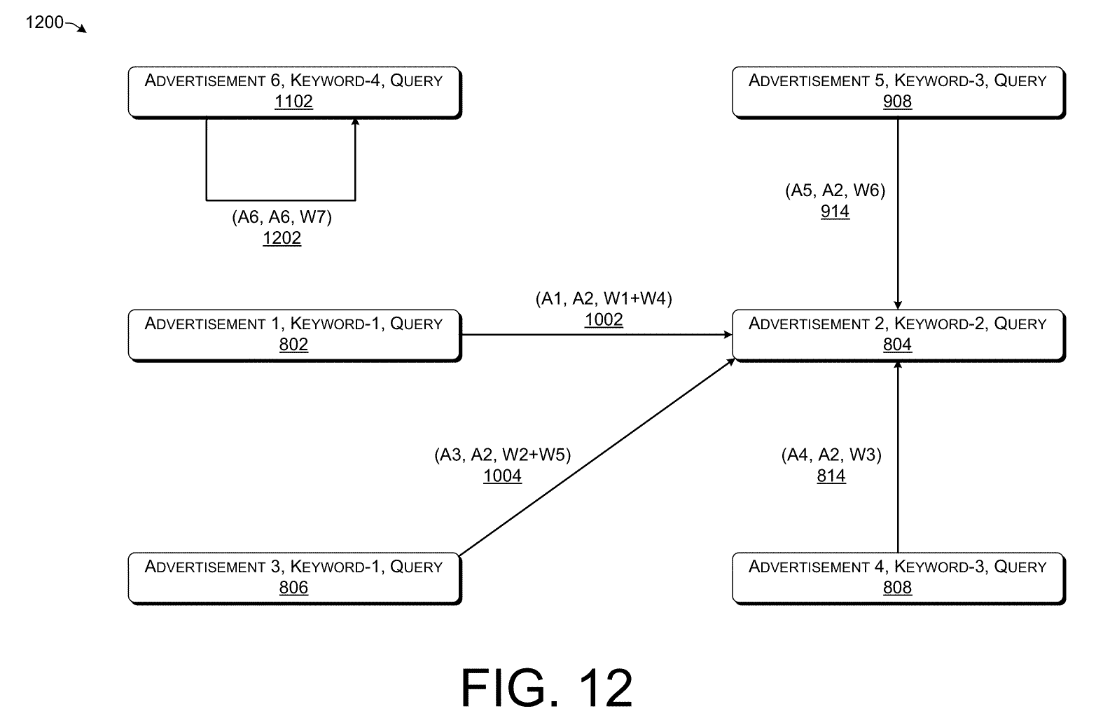

For the discussion of FIGS. 11 and 12 below, a subgraph will not be illustrated. Rather, FIGS. 11 and 12 directly show the relationship graph after the integration of the relationship subgraph for the queries discussed. As one of ordinary skill in the art would understand in view of this disclosure, the generation of the relationship subgraphs may be performed in the manner discussed above with regard to FIGS. 5-10

FIG. 11 illustrates an example relationship graph 1100 that provides context for the discussion of an example processing when a user does not click any of the presented advertisements or items. In particular, FIG. 11 illustrates the integration of a no-click subgraph into the relationship graph illustrated in FIG. 10.

In the illustrated scenario, the user 102 may enter the query and submit the query to the servers 112 using the user device 104. The servers 112 may provide the user 102 with a set of query results and sponsored advertisements in the manner discussed above with regard to FIGS. 8-10. For example, the user may be provided with advertisement 1, advertisement 2, advertisement 5 and advertisement 6. Nodes of the subgraph may be created that correspond to these advertisements. For example, the subgraph may include nodes similar to nodes 802, 804 and 908. In addition, the subgraph may include a node 1102 that represents the triple of advertisement 6, a keyword-4 and the query.

As mentioned above, FIG. 11 illustrates the handling according to some implementations of a scenario where the user does not click any of the provided advertisements. In particular, in the example implementation illustrated in FIG. 11, the relationship subgraph is integrated to the relationship graph 1100 by adding any absent nodes to the relationship graph without edges. As such, node 1102 is added without edges from the node 1102 to any other node in the relationship graph 1100.

The handling of no click subgraphs may vary from implementation to implementation. For example, in some implementations, the integration of no-click subgraphs into the relationship graphs may be skipped entirely or some other processing may be used.

FIG. 12 illustrates an example relationship graph 1200 that provides context for the discussion of an example processing when a single advertisement (or other item) is presented to a user and is clicked. In particular, FIG. 12 illustrates the integration of a single node with click subgraph into the relationship graph illustrated in FIG. 11.

In the scenario illustrated in FIG. 12, the user may enter the query and is presented with one result, advertisement 6. In the manner discussed above, the advertisement evaluation module 126 may then create a relationship subgraph including a node 1102 representing a triple for advertisement 6, keyword 4 and the query. When the user subsequently clicks advertisement 6, click information is received by the advertisement evaluation module 126 indicating this. As only node 1102 is included in the relationship subgraph, other nodes are not present for the instantiation of edges. Instead, some implementations according to FIG. 12 generate a “circular” edge 1202. In other words, an edge is generated that begins and ends at node 1102. As shown in FIG. 12, the triple of the edge label may be (Advertisement 6, Advertisement 6, Weight 7). Subsequently, the relationship subgraph may be integrated into the relationship graph 1100 shown in FIG. 11 to generate the relationship graph 1200 illustrated in FIG. 12.

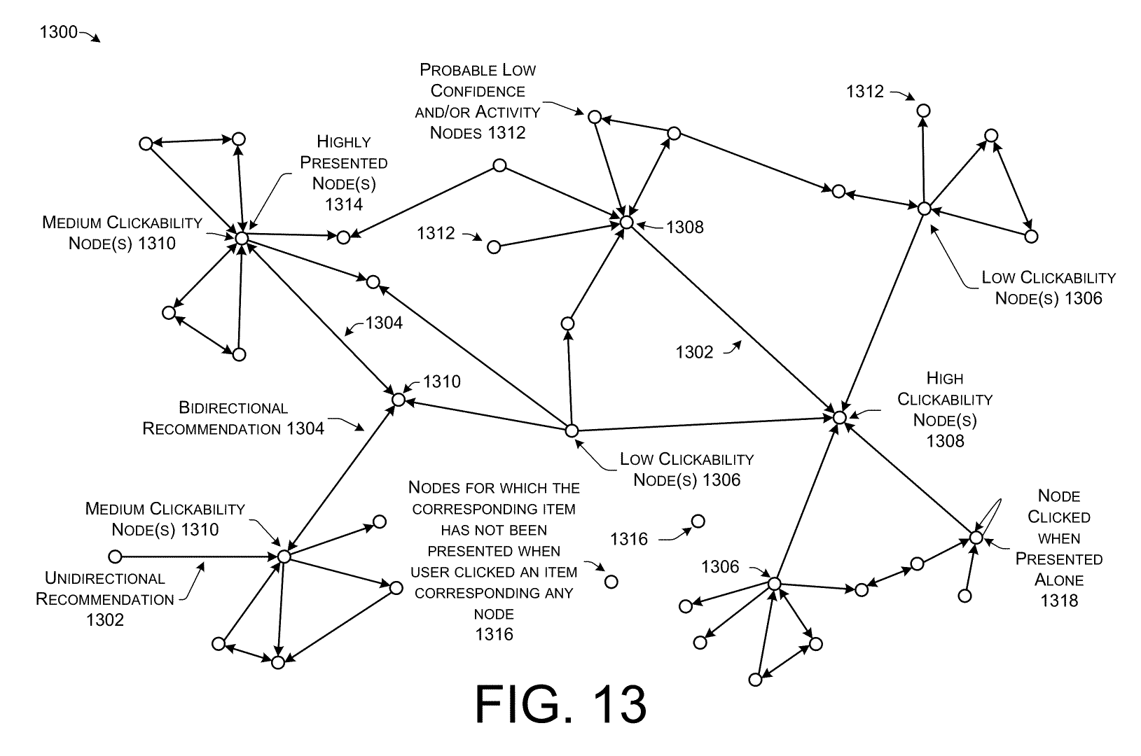

FIG. 13 illustrates an example relationship graph 1300 according to some implementations. In particular, the relationship graph 1300 is an example relationship graph similar to those illustrated in FIGS. 5-12 after several more subgraphs have been integrated into the relationship graph.

To allow for easier comprehension and general discussion, pairs of edges in both directions between pairs of nodes have been combined. As such, some links in relationship graph 1300 are unidirectional links 1302 and others are bidirectional links 1304. Further, the discussion below leaves out other factors such as the weighting of edges to allow for a simpler discussion of a relationship graph at this scale. More details on the utilization of the relationship graph will be provided following the discussion of FIG. 13.

Several observations can be made from the relationship graph 1300. Some nodes are “low” clickability nodes 1306, some are “high” clickability nodes 1308 and others are “medium” clickability nodes 1310. Of course, there is no standard that defines a low, medium, or high clickability and these terms are used herein are for convenience of the discussion below.

In the example implementation illustrated in FIG. 13, low clickability refers to nodes that have significantly more unidirectional outgoing edges than bidirectional edges or incoming unidirectional edges. To return to the recommendation terminology previously utilized, few other nodes recommend the low clickability nodes 1306 while the low clickability nodes 1306 recommend significantly more other nodes. For example, the low clickability node at the center of FIG. 13 recommends four other nodes and does not receive recommendations from any other node. Similarly, the low clickability node 1306 near the bottom right of FIG. 13 unidirectionally recommends four other nodes, has one bidirectional recommendation and receives one unidirectional recommendation.

In the example implementation illustrated in FIG. 13, high clickability refer to nodes that have significantly more unidirectional incoming edges than bidirectional edges or unidirectional outgoing edges. Returning to the recommendation terminology, a high clickability node 1308 is recommended by significantly more other nodes than the high clickability node 1308 recommends. For example, the high clickability node 1308 on the right side of FIG. 13 is recommended by five nodes and does not recommend any other node. Similarly, the high clickability node 1308 near the top center of FIG. 13 is unidirectionally recommended by four other nodes, has one bidirectional recommendation and unidirectionally recommends one other node. Depending on the implementation, the value of recommendations may also take into account the clickability of the recommending or recommended node. Take for example the one outgoing recommendation illustrated for the high clickability node 1308 near the top and center of FIG. 13 to the high clickability node 1308 located near the right side of FIG. 13. Because the recommended node is a high clickability node, the impact of the recommendation on the clickability of the recommending node may be adjusted. Similarly, the value of the recommendation to the recommended high clickability node 1308 may be higher as the recommending node is a high clickability node 1308.

As used with regard to FIG. 13, medium clickability nodes 1310 are nodes that fall into neither the high clickability range nor the low clickability range. For example, the medium clickability node 1310 at the top left of FIG. 13 has three bidirectional edges, two unidirectional outgoing edges and two unidirectional incoming edges. In the recommendation terminology, the top left medium clickability node 1310 gives the same number recommendations as node 1310 receives.

In some implementations, some nodes may not have clickability ratings or will be noted for having clickability ratings with a low confidence. Some examples of this are indicated in FIG. 13 as probable low confidence and/or activity nodes 1312. In contrast to highly presented nodes 1314, such as the medium clickability node 1310 illustrated at the top left of FIG. 13, probable low confidence and/or activity nodes 1312 may not have been presented often enough or against enough other nodes to provide a confident rating of their clickability. For example, the top center node 1312 has one incoming recommendation and one outgoing recommendation. Because the top center node 1312 has few edges, the clickability of the node 1312, while calculable, may or may not be accurate. It should be noted that, while this discussion refers to the number of edges, other factors may be taken into account such as the clickability of the nodes connected by the edges, the total number of presentations of the nodes and so on.

In the context of clickability ratings, the quantifier “significantly” may have different meanings for different implementations. For example, in some implementations, significantly more of a type of recommendation may be more than about double the number of recommendations, more than about two and a half times the number of recommendations, more than about triple the number recommendations, more than about quadruple the number recommendations and so on.

In addition of the features described above in FIG. 13, it should be noted that the relationship graph includes nodes 1316 and node 1318. Nodes 1316 are nodes for which the corresponding item has not been presented when a user clicked a presented item corresponding to any node. Such processing was discussed previously with regard to FIG. 11. The node 1318 is an example of a node corresponding to an item that was clicked when presented alone. Such processing was discussed previously with regard to FIG. 12. Because the item corresponding to node 1318 was clicked when presented alone, node 1318 includes a circular edge that begins with and ends at the node 1314.

FIG. 14 illustrates an example process flow 1400 according to some implementations. In particular, the process flow 1400 illustrates an example process by which a subgraph may be generated for a particular query and by which the subgraph may be integrated into a relationship graph as discussed above with regard to FIGS. 5-12.

At 1402, the advertisement evaluation module 126 may generate subgraph nodes corresponding at least in part to advertisements presented to a user in response to a query from the user. For example, the user may be presented with the advertisement results in a user interface similar to or distinct from the user interface 300 illustrated in FIG. 3. As discussed above with regard to FIGS. 7-12, the nodes may correspond to sets of features of the scenario in which the advertisement is presented. For example, the nodes illustrated in FIGS. 7-12 corresponded to triples of the advertisement, the matched keyword for the advertisement and the query itself.

At 1404, the advertisement evaluation module 126 may determine if the user has clicked one of the presented advertisements. If so, the process moves to 1406. Otherwise, the process moves to 1414.

At 1406, the advertisement evaluation module 126 determines the number of nodes in the subgraph and, if the subgraph includes one node, the process moves to 1408. Otherwise, if the subgraph includes a plurality of nodes, the process moves to 1410.

At 1408, when an advertisement that is presented alone is clicked, the advertisement evaluation module 126 may generate a circular edge that begins with and ends at the clicked node. At 1410, the advertisement evaluation module 126 may generate edges from each of the unclicked nodes to the clicked node. At 1412, the advertisement evaluation module 126 may determine edge weights for each edge of the subgraph. Blocks 1408-1412 may be performed in a similar manner to that discussed above with regard to FIGS. 5-11.

At 1414, the advertisement evaluation module 126 may determine which nodes of the relationship subgraph are not present in the relationship graph and add nodes to the graph that correspond to the determined nodes. At 1416, the advertisement evaluation module 126 may determine which edges of the relationship graph are not present in the relationship graph. The advertisement evaluation module 126 may then add edges to the relationship graph for the edges determined to not be present in the relationship graph. At 1418, the advertisement evaluation module 126 may integrate edge weights of the subgraph edges into the corresponding edges of the relationship graph. For example, if an edge present in the relationship graph has a weight of X and the corresponding edge in the subgraph has weight of Y, the edge weight for the integrated edge may be the sum of X and Y (i.e. X+Y). Of course, other integrations of the edge weights may be used. For example, an averaging mechanism may be used to limit the impact of any given edge weight be integrated to the relationship graph.

In some implementations, the relationship graph may be created from a batch of subgraphs rather than on a subgraph by subgraph basis. The results of the batch processing (or the sequential processing described above) may be represented by a matrix A(N*N) where N is the number of <query, ad, matched keyword> triples that exist in the relationship subgraphs, A(i,j)=Σₖ w_{i,j,k}, i is the head node in a given edge, j is an end node of a given edge, k is the number of occurrences of the edge in all the relationship subgraphs, and w_{i,j,k} is the edge weight in the kth occurrence of the edge in the relationship subgraphs.

Having generated a relationship graph such as the relationship graphs shown and described in FIGS. 5-13, the advertisement evaluation module 126 may utilize the relationship graph in various ways to determine a clickability score for the advertisements. For example, in some implementations, the relationship graph may be output to allow for visualization of the clickability relationships. Alternatively or additionally, in some implementations, based on the graph, the server 112 may utilize an algorithm, Pagerank for example, to determine a clickability ranking score for the advertisements of relationship graph.

More particularly, some implementations may user the graph built based on the advertisements click history to compute ranks based on a recommendation graph. As mentioned above, the PageRank algorithm may be utilized in some implementations to compute the rank of a particular <advertisement, keyword, query> triple. To utilize the PageRank algorithm, some implementations further convert the matrix A discussed above into a transition probability matrix P(N*N). Some implementations may utilize the following formula to convert the matrix A to matrix P:

$${P}_{i , j} = \{ \begin{matrix}\frac{{w}_{i , j}}{{\sum }_{i} {w}_{i , j}} , & {\sum }_{i} {w}_{i , j} > 0 \\ \frac{1}{N} , & {\sum }_{i} {w}_{i , j} = 0\end{matrix}$$

Using the above formula, some implementations leverage the Page Rank algorithm to compute a detailed rank score X={x₁, x₂, . . . , xₙ}^{T} for the <advertisment, keyword, query> triple. The rank score may be used in various techniques. For example, the rank score may be used directly as a predicted click probability for the advertisement. Another example utilization of the detailed rank score is discussed below.

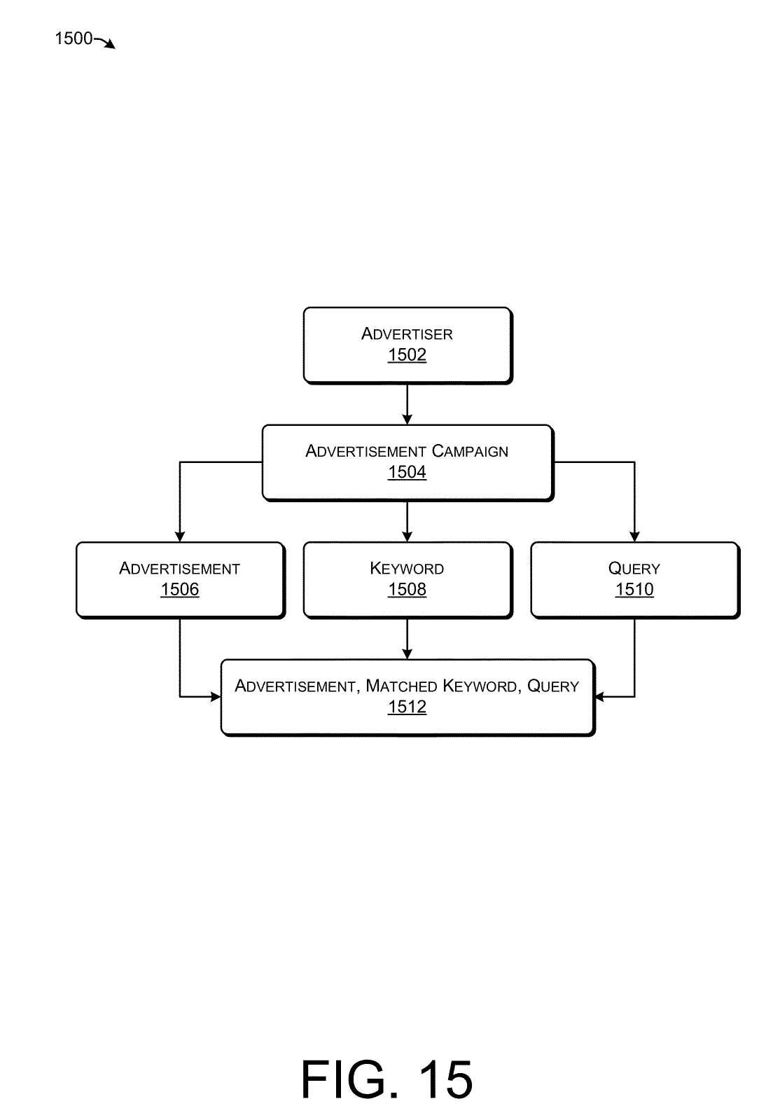

In particular, in some implementations, the detailed rank score for the triples may be utilized as one among a plurality of features. For example, some implementations may aggregate multiple layers of scores like query level, keyword level, advertisement level, advertiser level and so on as other features. In some applications of the techniques and systems disclosed herein, a hierarchy may exist among these features. Such an example hierarchy of features 1500 is shown in FIG. 15. As shown in FIG. 15, features may be ranked in the hierarchy from high level feature to low level feature. For example, in the example hierarchy of features 1500, the top level feature is the advertiser feature 1502 associated with the advertisement. The second level includes an advertisement campaign feature 1504 associated with the advertisement. The third level includes the advertisement as a feature 1506, a keyword feature 1508 (matched keywords), and a query feature 1510. Finally, the fourth and lowest level of the illustrated feature hierarchy includes the triple feature 1512 which is based on the triple of the advertisement, the keyword and the query.

In some implementations in which such a hierarchy 1500 of features is utilized in the ranking of advertisements, the various rank scores from the hierarchy may be summed to obtain the overall rank score. However, other techniques may be utilized.

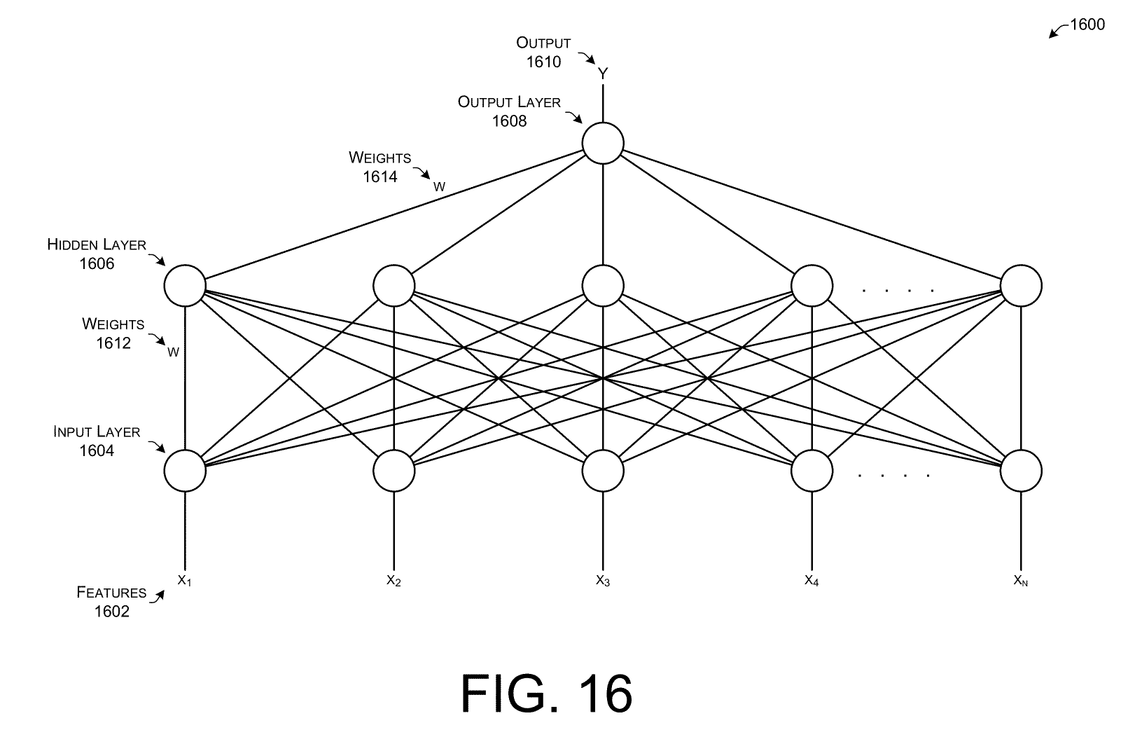

FIG. 16 illustrates the use of machine learning according to some implementations to obtain a rank score based on a plurality of features. In particular, FIG. 16 illustrates another approach which utilizes a neural network 1600 to obtain a rank score for advertisements based on a plurality of features including the ranking of the relationship graph.

As shown in FIG. 16, the neural network includes features 1602 (x₁, x₂, x₃, x₄, . . . xₙ) that are input to the input layer 1604 of the neural network 1600. The nodes of the input layer 1604 forward the features 1602 to the hidden layer(s) 1606 by the connections. The nodes of the layer(s) 1604-1606 perform operations that transform the features 1602 until the output layer 1608 is reached and the output layer 1608 outputs the output 1610, shown in FIG. 16 as “Y”. As mentioned, the nodes perform various functions and transformations which may be based on the weights 1612 and 1614 of the connection between nodes.

Using the neural network illustrated in FIG. 16, some implementations may train a prediction model based on the features 1602 which may generate the click probability of the particular triple of an advertisement, matched keyword and query. For example, over a set of training data, the advertisement evaluation module 126 may operate to adjust the weights w 1612-1614 for the edges so as to minimize logloss. (e.g. using the formula Σᵢ {ŷₗ*log(yᵢ)+(1−ŷ)*log (1−yᵢ)}).

The above discussion provided many example details regarding the example functionality and/or example of the servers 112. However, implementations of the techniques and systems according to this disclosure are not limited to the above described details. Variations on the details of the systems and techniques described above would be apparent to one of ordinary skill in the art in view of this disclosure.

Further, the discussion herein refers to data being sent and received by particular components or modules of a system. This should not be taken as a limitation as such communication need not be direct and the particular components or modules need not necessarily be single functional units. The communications could instead be relayed by a separate module upon receipt of the communication. Further, the components and/or modules may be combined or the functionality may be separated amongst modules in various manners not limited to those discussed above.

Other variations in the logical and practical structure and framework of various implementations would be apparent to one of ordinary skill in the art in view of the disclosure provided herein.

Further, the processes described herein are only examples provided for discussion purposes. Numerous other variations will be apparent to those of skill in the art in light of the disclosure herein. Further, while the disclosure herein sets forth several examples of suitable frameworks, architectures and environments for executing the techniques and processes herein, implementations herein are not limited to the particular examples shown and discussed.

Furthermore, this disclosure provides various example implementations, as described and as illustrated in the drawings. However, this disclosure is not limited to the implementations described and illustrated herein, but can extend to other implementations, as would be known or as would become known to those skilled in the art in view of this disclosure. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

What is claimed is:

1. A computing system comprising:
one or more processors;
a memory;
one or more advertisement evaluation modules stored in the memory and executable by the one or more processors to:
generate a plurality of subgraph nodes of a relationship subgraph based at least in part on a presentation of a plurality of advertisements associated with respective subgraph nodes of the plurality of subgraph nodes to a client;
receive an indication of a selection by the client of an advertisement associated with one of the plurality of subgraph nodes of the relationship subgraph;
generate one or more edges of the relationship subgraph from one or more respective unselected subgraph nodes associated with advertisements presented concurrently with the selected advertisement to a subgraph node corresponding to the selected advertisement;
determine a weight to be associated with at least one of the generated edges of the subgraph; and
integrate the relationship subgraph into a relationship graph.

2. The computing system of claim 1, wherein at least one edge weight of the relationship subgraph is determined based at least in part on relative presentation in the presentation of the advertisements corresponding to the respective subgraph nodes of the plurality of subgraph nodes connected by the edge.

3. The computing system of claim 1, wherein at least one edge weight of an edge of the relationship graph is based at least in part on a summation of a plurality of weights for a plurality of respective concurrent presentations of the advertisements corresponding to respective relationship graph nodes of a plurality of relationship graph nodes of the relationship graph connected by the edge.

4. The computing system of claim 3, wherein the plurality of weights of the summation of the plurality of weights are weights of a plurality of respective subgraphs.

5. The computing system of claim 1, wherein at least one subgraph node represents at least an advertisement, a matched keyword and a query from the client.

6. The computing system of claim 1, wherein the integrating comprises:
determining whether one or more subgraph nodes of the relationship subgraph correspond to graph nodes of the relationship graph;
generating one or more graph nodes of the relationship graph corresponding to subgraph nodes determined to not have corresponding graph nodes;
determining whether one or more subgraph edges connecting pairs of subgraph nodes of the relationship subgraph correspond at least in part to graph edges connecting pairs of graph nodes of the relationship graph; and
generating one or more graph edges of the relationship graph corresponding to subgraph edges determined to not have corresponding graph edges.

7. One or more computer-readable media storing instructions that, when executed by one or more processors of a computing system, cause the one or more processors to perform acts of one or more modules operable to:
generate one or more subgraph nodes of a relationship subgraph based at least in part on a presenting of one or more items associated with one or more associated subgraph nodes of the one or more subgraph nodes to a client;
receive an indication of a selection by the client of an item associated with one of the one or more associated subgraph nodes of the relationship subgraph; and
generate one or more edges of the relationship subgraph from one or more respective unselected subgraph nodes associated with items presented concurrently with the selected item to the one of the one or more subgraph node associated with the selected item.

8. The one or more computer-readable media of claim 7, the one or more modules executable by the one or more processors to integrate the relationship subgraph into a relationship graph.

9. The one or more computer-readable media of claim 7, the one or more modules executable by the one or more processors to determine a weight to be associated with at least one of the one or more generated edges of the subgraph.

10. The one or more computer-readable media of claim 7, the one or more modules executable by the one or more processors to:
receive an indication of a selection by the client of a particular item associated with an associated subgraph node of a second relationship subgraph where the particular item is presented without other items associated with the subgraph nodes of the second relationship subgraph; and
generate an edge of the second relationship subgraph from the subgraph node associated with the particular item to the subgraph node associated with the particular item.

11. The one or more computer-readable media of claim 7, the one or more modules executable by the one or more processors to
generate one or more third subgraph nodes of a third relationship subgraph based at least in part on a presentation of one or more items associated with the one or more associated third subgraph nodes of the one or more third subgraph nodes to a client; and
in the absence of an indication of a selection by the client of a third item associated with the one or more associated third subgraph nodes of the third relationship subgraph, integrate the third relationship subgraph into a relationship graph without generating edges of the third relationship subgraph.

12. The one or more computer-readable media of claim 7, the one or more modules executable by the one or more processors to integrate the relationship subgraph into a relationship graph.

13. The one or more computer-readable media of claim 12, wherein the plurality of relationship graph nodes associated with a first item are associated with respective search queries from the client.

14. A computer-implemented method comprising:
under control of one or more processors configured with executable instructions,
integrating a relationship subgraph into a relationship graph, one or more subgraph nodes of the relationship subgraph associated with one or more items presented concurrently to a particular client of one or more clients and one or more graph edges of the relationship graph indicating that one of one or more graph nodes was selected by one or more clients when presented concurrently to the one or more clients
storing the result of the integrating of the relationship subgraph into a relationship graph.

15. The computer-implemented method of claim 14, the integrating comprising:
determining whether one or more subgraph nodes of the relationship subgraph correspond to graph nodes of the relationship graph;
generating one or more graph nodes of the relationship graph corresponding to subgraph nodes determined to not have corresponding graph nodes;
determining whether one or more subgraph edges connecting pairs of subgraph nodes of the relationship subgraph correspond at least in part to graph edges connecting pairs of graph nodes of the relationship graph; and
generating one or more graph edges of the relationship graph corresponding to subgraph edges determined to not have corresponding graph edges.

16. The computer-implemented method of claim 15, the integrating further comprising:
determining an adjusted weight of at least one graph edges corresponding to a subgraph edge determined to have a corresponding graph edge based at least in part on a summation of a weight of the graph edge and a weight of the corresponding subgraph edge.

17. The computer-implemented method of claim 16, wherein at least one edge of the relationship graph begins with a particular node and ends at the particular node indicating that an associated item of the particular graph node was presented to one or more clients and clicked when other items associated with the graph nodes were not being concurrently presented.

18. The computer-implemented method of claim 17, wherein at least one edge weight of an edge of the relationship subgraph is determined based at least in part on relative presentation in the presenting of the items corresponding to the respective subgraph nodes of the plurality of subgraph nodes connected by the edge.

19. The computer-implemented method of claim 14, wherein the one or more items are advertisements.

20. The computer-implemented method of claim 14, wherein at least one subgraph node represents at least an advertisement, a matched keyword and a query from the client.
